(19) United States
(12) Patent Application Publication
(10) Pub. No.: US 2014/0204047 A1
(43) Pub. Date: Jul. 24, 2014

(54) TOUCH PANEL

(71) Applicant: HENGHAO TECHNOLOGY CO., LTD, Taoyuan County (TW)

(72) Inventor: Chien-Wen Lai, New Taipei City (TW)

(73) Assignee: HENGHAO TECHNOLOGY CO. LTD, Taoyuan County (TW)

(21) Appl. No.: 13/751,139

(22) Filed: Jan. 27, 2013

(30) Foreign Application Priority Data
Jan. 22, 2013 (TW) 102102279

(51) Int. Cl. G06F 3/044

(52) U.S. Cl. CPC G06F 3/044
USPC 345/174

(57) ABSTRACT

A touch panel includes a touch electrode layer disposed on a touch area of a transparent substrate, and a light shielding layer disposed on a boundary area of the transparent substrate. At least one inner edge of the light shielding layer has plural trenches filled with conductive material. A trace layer is disposed on the light shielding layer and is electrically coupled with the touch electrode layer via the filled conductive material.

### CROSS-REFERENCE TO RELATED APPLICATIONS

The entire contents of Taiwan Patent Application No. 102102279, filed on Jan. 22, 2013, from which this application claims priority, are incorporated herein by reference.

### BACKGROUND OF THE INVENTION

1. Field of the Invention

The present invention generally relates to a touch panel, and more particularly to a touch panel with a light shielding layer having plural trenches.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch position. Specifically, capacitance corresponding to the touch position changes and is thus detected, when a finger touches a surface of the touch panel.

In a conventional touch panel, a touch electrode layer is disposed between two pieces of glass that are fixed to each other by optical clear adhesive. As the two-glass structure suffers low light transmittance and low yield, a one-glass structure is thus proposed. A touch panel of the one-glass structure, however, still possesses some drawbacks. For example, a touch electrode layer and a trace layer usually have bad electrical coupling, or even, broken lines, in the boundary area of the touch panel.

A need has thus arisen, to propose a novel touch panel to overcome deficiencies of the conventional touch panels.

### SUMMARY OF THE INVENTION

In view of the foregoing, it is an object of the embodiment of the present invention to provide a touch panel with a light shielding layer having plural trenches at its inner edge, therefore simplifying process, increasing yield, preventing broken lines and facilitating inspecting or repairing.

According to one embodiment, a touch panel includes a transparent substrate, a touch electrode layer, a light, shielding layer, filled conductive material and a trace layer. The touch electrode layer is disposed on a touch area of the transparent substrate, and the light shielding layer is disposed on a boundary area of the transparent substrate. At least one inner edge of the light shielding layer has a plurality of trenches filled with conductive material. The trace layer is disposed on the light shielding layer, and is electrically coupled with the touch electrode layer via the filled conductive material.

### BRIEF DESCRIPTION OF THE DRAWINGS

FIG. 1 shows a cross-sectional view of a touch panel according to a first embodiment of the present invention;

FIG. 2 shows an exploded view of some composing elements of the touch panel of FIG. 1; and

FIG. 3 shows a top view of the light shielding layer of a touch panel according to a second embodiment of the present invention.

### DETAILED DESCRIPTION OF THE INVENTION

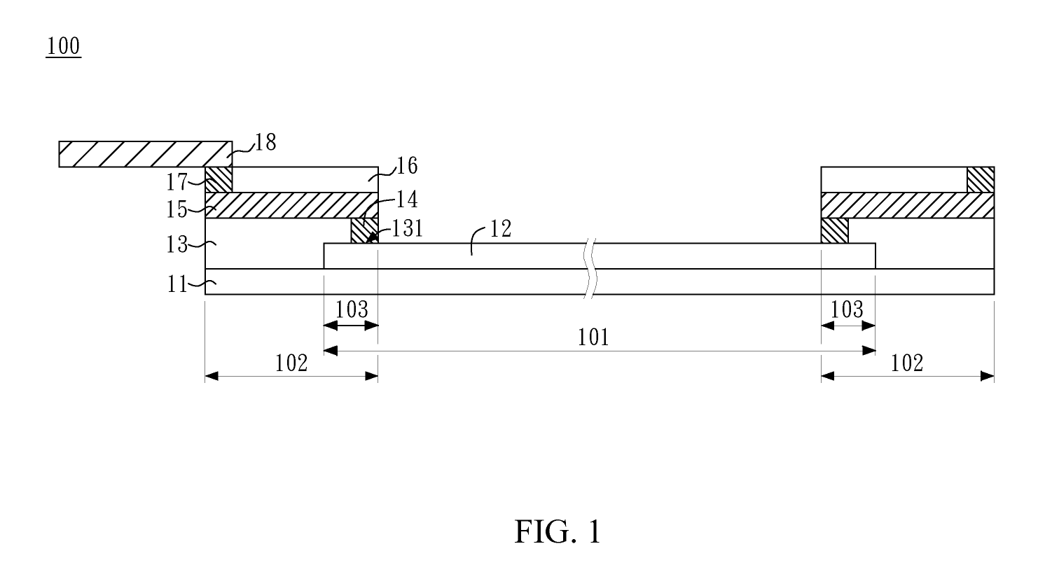

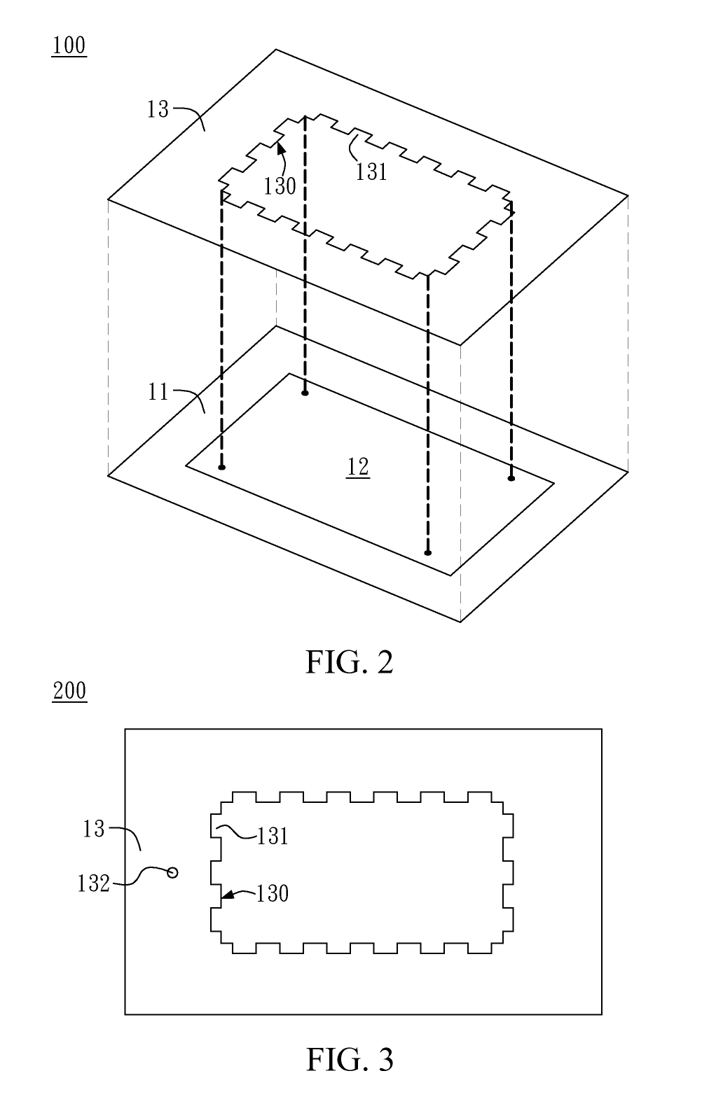

FIG. 1 shows a cross-sectional view of a touch panel 100 according to a first embodiment of the present invention, and FIG. 2 shows an exploded view of some composing elements of the touch panel 100. In the embodiment, a touch electrode layer 12 is disposed on a surface (e.g., a top surface) of a touch area 101 of a transparent substrate 11. Generally speaking, the touch area 101 may, but not necessarily, be located in a center of the transparent substrate 11. In the specification and drawings, the direction “bottom” may point to a touch surface of the touch panel 100, and the direction “top” may point to a display (not shown).

The transparent substrate 11 of the embodiment may include insulating material such as glass, Polycarbonate (PC), Polyethylene terephthalate (PET), Polyethylen (PE), Poly vinyl chloride (PVC), Poly propylene (PP), Poly styrene (PS), Polymethyl methacrylate (PMMA) or Cyclic olefin copolymer (COC).

The touch electrode layer 12 of the embodiment may include a light-transmissive structure made of a non-transparent material. The non-transparent material may include metal nanowires (e.g., silver nanowires or copper nanowires) or metal nanonets (e.g., silver nanonets or copper nanonets). The metal nanowires or nanonets have a diameter in a nanometer order (i.e., a few nanometers to hundreds nanometers), and may be fixed via a plastic material (e.g., resin). Due to fineness of the metal nanowires/nanonets unobservable to human eyes, the touch electrode layer 12 made of the metal nanowires/nanonets thus has high light-transmittance. The touch electrode layer 12 may further include a photosensitive material (e.g., acrylic), through which electrodes with a required pattern may be formed via an exposure development process.

In another embodiment, the touch electrode layer 12 may include a light-transmissive structure made of a transparent material. The transparent material may include indium tin oxide (ITO), indium, zinc oxide (IZO), Al-doped ZnO (AZO) or antimony tin oxide (ATO).

Subsequently, a light shielding layer 13, such as a black matrix (BM) layer or an insulating ink layer, is disposed on a boundary area 102 of the transparent substrate 11. As shown in FIG. 2, the light shielding layer 13 has a hollow frame structure made of four edges. In another embodiment, however, the light shielding layer 13 may be made of three or less edges. As shown in FIG. 1, an overlapping area 103 exists between the light shielding layer 13 and the touch electrode layer 12 such that a portion of the light shielding layer 13 covers a portion of the touch electrode layer 12.

According to one aspect of the embodiment, as shown in FIG. 1/2, the light shielding layer 13 has at least one inner edge 130 facing the center of the touch panel 100 and having plural trenches 131. The trenches 131 are filled with conductive material 14. It is noted that, as the trenches 131 of the embodiment is disposed at the inner edge 130 of the light shielding layer 13, no hole boring process is required, therefore simplifying process and increasing yield. Moreover, as the conductive material 14 is filled in the trenches 131 instead of holes, filling process becomes easy and broken lines seldom occur. Further, it facilitates inspecting or repairing.

Afterwards, a trace layer 15 is disposed on the light shielding layer 13 and is electrically coupled with the touch electrode layer 12 via the filled conductive material 14. An insulating layer 16 subsequently covers the trace layer 15. As shown in FIG. 1, the insulating layer 16 has an opening filled with conductive adhesive 17 for electrically coupling the trace layer 15 with a circuit board 18 such as a flexible printed circuit board (FPC). A top surface of the structure shown in FIG. 1 may be further coupled with a display (not shown), such as a liquid crystal display, to result in a touch screen.

FIG. 3 shows a top view of the light shielding layer 13 of a touch panel 200 according to a second embodiment of the present invention. In the embodiment, in addition to plural trenches 131 disposed at the inner edge 130 of the light shielding layer 13, a single hole 132 is formed in the light shielding layer 13, for example, for setting a logo or a symbol.

Although specific embodiments have been illustrated and described, it will be appreciated by those skilled in the art that various modifications may be made without departing from the scope of the present invention, which is intended to be limited solely by the appended claims.

What is claimed is:

1. A touch panel, comprising:
a transparent substrate;
a touch electrode layer disposed on a touch area of the transparent substrate;
a light shielding layer disposed on a boundary area of the transparent substrate, of which at least one inner edge having a plurality of trenches;
filled conductive material filled in the plurality of trenches; and
a trace layer disposed on the light shielding layer, the trace layer being electrically coupled with the touch electrode layer via the filled conductive material.

2. The touch panel of claim 1, wherein an overlapping area exists between the light shielding layer and the touch electrode layer such that a portion of the light shielding layer covers a portion of the touch electrode layer.

3. The touch panel of claim 1, further comprising an insulating layer covering the trace layer.

4. The touch panel of claim 1, wherein the light shielding layer has a hole formed therein.

5. The touch panel of claim 3, wherein the insulating layer has an opening filled with conductive adhesive.

6. The touch panel of claim 5, further comprising a circuit board that is electrically coupled with the trace layer via the conductive adhesive.

7. The touch panel of claim 6, wherein the circuit board comprises a flexible printed circuit board.

8. The touch panel of claim 1, wherein the light shielding layer comprises a black matrix layer or an insulating ink layer.

9. The touch panel of claim 1, wherein the light shielding layer comprises a hollow frame structure made of four edges.

10. The touch panel of claim 1, wherein the transparent substrate comprises glass, Polycarbonate (PC), Polyethylene terephthalate (PET), Polyethylen (PE), Poly vinyl chloride (PVC), Poly propylene (PP), Poly styrene (PS), Polymethyl methacrylate (PMMA) or Cyclic olefin copolymer (COC).

11. The touch panel of claim 1, wherein the touch electrode layer comprises a plurality of metal nanowires or a plurality of metal nanonets.

12. The touch panel of claim 1, wherein the touch electrode layer comprises indium, tin oxide (ITO), indium zinc oxide (IZO), Al-doped ZnO (AZO) or antimony tin oxide (ATO).
